(19) United States
(12) Patent Application Publication
(10) Pub. No.: US 2021/0321686 A1
(43) Pub. Date: Oct. 21, 2021

(54) Nourishment Device For Mask

(71) Applicant: Peter Crawford, Wayzata, MN (US)

(72) Inventor: Peter Crawford, Wayzata, MN (US)

(21) Appl. No.: 16/853,465

(22) Filed: Apr. 20, 2020

(51) Int. Cl. A41D 13/11

(52) U.S. Cl. CPC A41D 13/11

(57) ABSTRACT

A device for removably fastening to a protective headwear to more safely permit nourishment includes a ring-shaped body and a membrane. The body has an outer surface and defines an inner opening. The outer surface of the body is mountable about a hole in the protective headwear such that the inner opening of the body at least partially overlaps with the hole. A membrane is connected to the body to substantially close the inner opening. At least one slit in said membrane to permit passage of a utensil through the membrane.

### TECHNICAL FIELD

The present disclosure generally relates to protective headwear. The present disclosure more particularly relates to a device for removably fastening to a mask to more safely permit nourishment, and a protective headwear that includes the mask and the device.

### BACKGROUND

The COVID-19 pandemic has made protective headwear (e.g., masks, googles) ubiquitous. In some instances, governments have ordered the public to wear masks at all times outside the home to prevent further spread of the disease. The widespread use of masks and other protective headwear is expected to continue even after COVID-19 dissipates, especially in situations that present real or perceived risk of disease transmission, such as air travel.

The need to wear masks at all times outside the home presents a number of problems. Among other things, the wearer inevitably faces the need for nourishment (e.g., food, drink). Because the mask covers at least a mouth region of the wearer, the mask must be at least partially removed to permit nourishment. The process of removing the mask and then reapplying the mask increases the risk that the wearer will expose others to a disease that the wearer is carrying, and/or increases the risk that the wearer will be exposed to a disease present in the surrounding environment.

Masks and other protective headwear are typically designed to be disposed of after a single use. It is common for a wearer to go through a high volume of masks, even in non-medical settings. The need to maintain low cost of each mask is highly important to consumers. Designing a mask with extra built-in features increases price and is therefore discouraged.

Aspects of the present invention are directed to these and other problems.

### SUMMARY

According to an aspect of the present invention, a device for removably fastening to a protective headwear to more safely permit nourishment includes a ring-shaped body and a membrane. The body has an outer surface and defines an inner opening. The outer surface of the body is mountable about a hole in the protective headwear such that the inner opening of the body at least partially overlaps with the hole. A membrane is connected to the body to substantially close the inner opening. At least one slit in said membrane to permit passage of a utensil through the membrane.

According to another aspect of the present invention, a mask that permits drinking therethrough includes a hole in the mask in a region of a mouth of the wearer, and a device for removably fastening to said hole in the mask. The device includes a body having an outer surface and defining an inner opening, a membrane connected to the body to substantially close the inner opening, and at least one slit in said membrane to permit passage of a straw to more safely permit drinking through the mask.

In addition to, or as an alternative to, one or more of the features described above, further aspects of the present invention can include one or more of the following features, individually or in combination:
the outer surface of said body includes an annular groove that engages an edge of the protective headwear that defines the hole;
said body includes a first and second body portions that engage inner and outer surfaces of the protective headwear when the first and second body portions are removably fastened together;
one of said first and second body portions includes a sharp edge for piercing the protective headwear to form the hole;
the first and second body portions are snap-fit;
the first and second body portions are removably connectable via a threaded connection;
at least one of the first and second body portions includes radial ribs to facilitate rotation of the one of the body portions relative to the other body portion for assembly and removable of said body to the headwear;
the utensil is a straw;
the mask is a respirator mask;
the mask is an n95 mask;
the mask is a surgical mask;
the mask is a buff;
the mask is a neck gaiter;
said body includes first and second body portions that engage opposite sides the mask about said hole;
the first body portion includes a sharp edge that extends axially from the inner opening, and the second body portion includes an annular flange that extends radially from the inner opening to receive said sharp edge when the first and second body portions are fit together to create said hole by cutting the mask;
the first and second body portions are fit together via snap connection;
the and second first body portions fit together via threaded connection;
at least one of said first and second body portions includes radial ribs to facilitate rotation of the one of the body portions relative to the other body portion for assembly and removable of said device to the mask; and
the masking includes four slits in said membrane.

These and other aspects of the present invention will become apparent in light of the drawings and detailed description provided below.

### BRIEF DESCRIPTION OF THE DRAWINGS

FIG. 1 is an isometric view of a protective headwear including a mask and a device removably fastened to the mask to more safely permit nourishment.

FIG. 2 is an isometric view of the protective headwear of FIG. 1 after a straw has been passed through the device.

FIG. 3 schematically illustrates the mask and the device of FIG. 1 before installation of the device.

FIGS. 4 and 5 schematically illustrate installation of the device of FIG. 1 relative to the mask.

FIG. 6 schematically illustrates the mask and the device of FIG. 1 after the straw has been passed through the device.

FIG. 7 is an isometric exploded view of the device of FIG. 1.

FIG. 8 is a cross-sectional elevation view of the device of FIG. 1.

FIG. 9 schematically illustrates another protective headwear including a mask with hole.

FIG. 10 schematically illustrates the protective headwear of FIG. 9 after installation of the device into the hole of the mask.

FIG. 11 schematically illustrates the protective headwear of FIG. 9 after a straw has been passed through the device.

FIG. 12 schematically illustrates the mask and the device of FIG. 9 before installation of the device.

FIG. 13 schematically illustrates the device of FIG. 9 after installation relative to the mask.

FIG. 14 schematically illustrates the mask and the device of FIG. 9 after the straw has been passed through the device.

### DETAILED DESCRIPTION

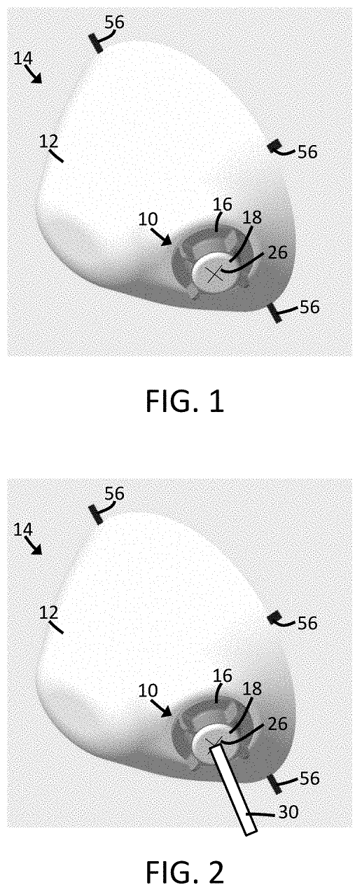

Referring to FIGS. 1-2 and 9-11, the present disclosure describes a device 10 for removably fastening to a mask 12 to more safely permit nourishment, and a protective headwear 14 that includes the mask 12 and the device 10.

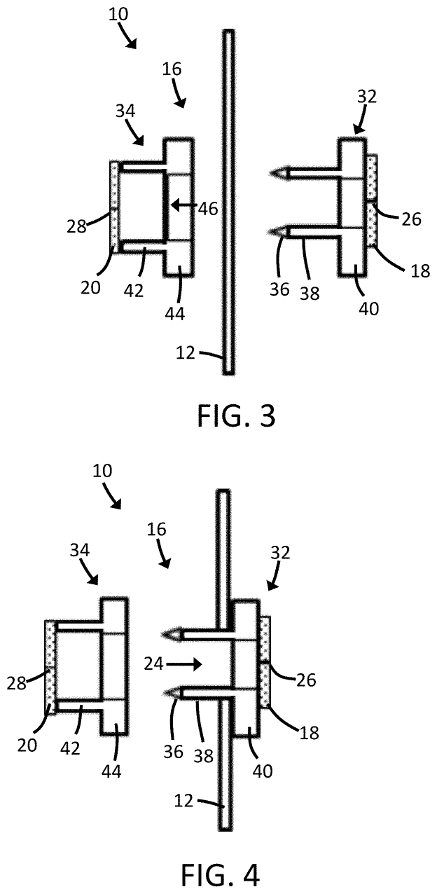

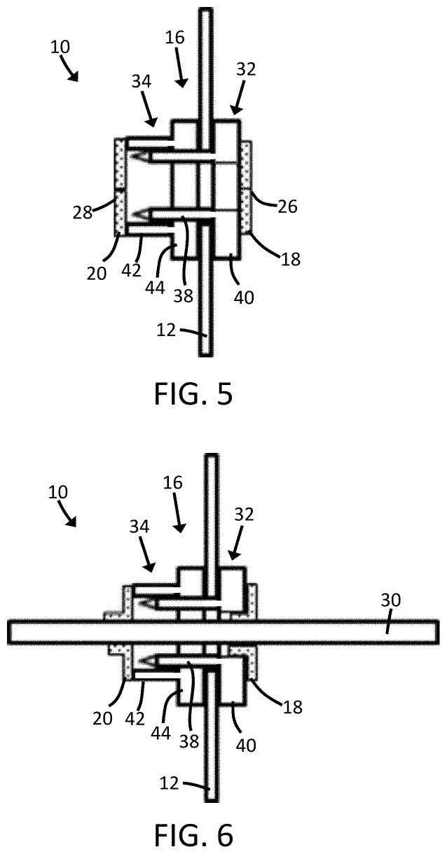

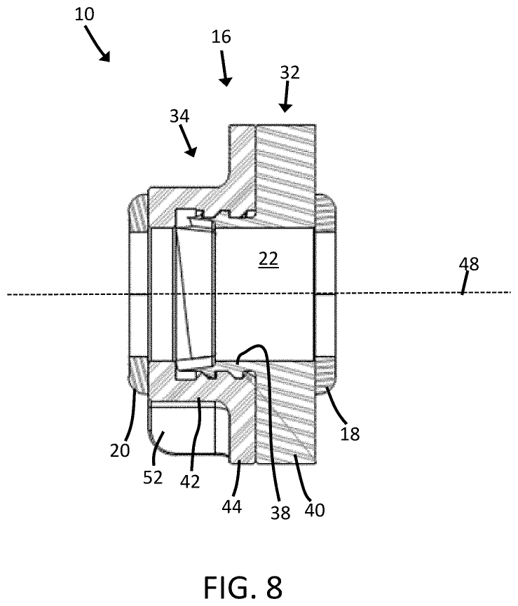

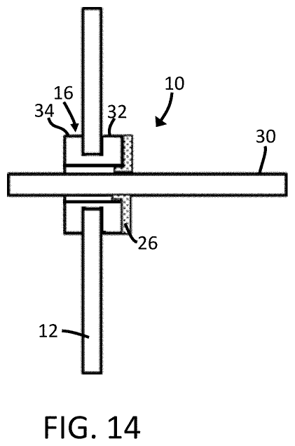

Referring to FIGS. 3-8 and 12-14, the device 10 includes a ring-shaped body 16 and at least one membrane 18, 20. The body 16, which may be in the form of a grommet, has an outer surface and defines an inner opening 22 (see FIGS. 8, 12, 13). The outer surface of the body 16 is mountable about a hole 24 (see FIG. 4, 9, 12, 13) in the mask 12 in a mouth region of the wearer, such that the inner opening 22 of the body 16 at least partially overlaps with the hole 24. The membrane 18, 20 is connected to the body 16 to substantially close the inner opening 22. The membrane 18, 20 includes at least one slit 26, 28 to permit passage of a utensil 30 (e.g., a straw) through the membrane 18, 20.

Referring to FIGS. 3-8 and 12-14, the body 16 of the device 10 includes first and second body portions 32, 34 that engage respective surfaces on opposite sides of the mask 12. In the illustrated embodiments, the first body portion 32 engages an outer side surface of the mask 12, while the second body portion 34 engages an inner side surface of the mask 12.

In some embodiments (see FIGS. 1-8), the first and second body portions 32, 34 of the device 10 are discrete components that are removably connectable to one another (e.g., via a snap-fit or threaded connection). In some such embodiments, at least one of the first and second body portions 32, 34 includes a sharp edge 36 for piercing the mask 12 to form the hole 24. Referring to FIGS. 3-8, in the illustrated embodiment, the first body portion 32 includes an annular collar 38 that at least partially defines the inner opening 22 (see FIG. 8), and an annular flange 40 that extends radially from the collar 38. The second body portion 34 similarly includes an annular collar 42 and an annular flange 44 that extends radially from the collar 42. The sharp edge 36 (see FIGS. 3-4) is provided on the end of the collar 38 of the first body portion 32 opposite the flange 40. The flange 44 of the second body portion 34 defines an opening 46 (see FIG. 3) configured to receive the sharp edge 36 of the first body portion 32 when the first and second body portions 32, 34 are fit together to create the hole 24 (see FIG. 4) by cutting the mask 12, as shown sequentially in FIGS. 3-5. When connected to one another, the first and second body portions 32, 34 are concentrically aligned relative to an axis 48 of the device 10.

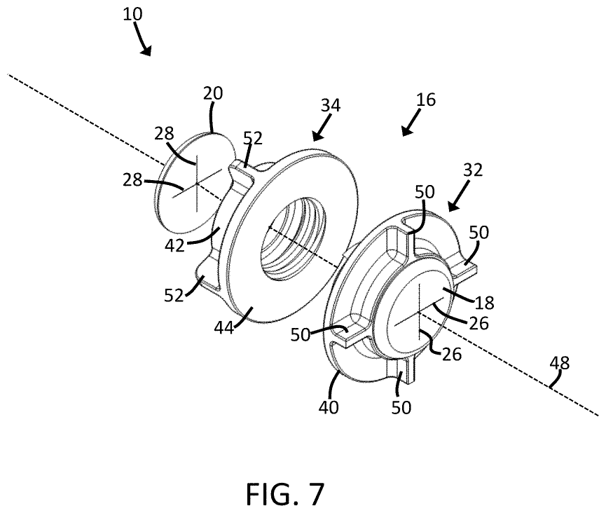

Referring to FIG. 7, in some embodiments in which the first and second body portions 32, 34 of the device 10 are discrete components that are removably connectable to one another, at least one of the first and second body portions 32, 34 includes radial ribs 50, 52 to facilitate rotation of the one of the body portions 32, 34 relative to one another for installation and removal of the device 10 relative to the mask 12. Referring to FIGS. 7 and 8, in the illustrated embodiment, the flange 40 of the first body portion 32 includes four (4) radial ribs 50 disposed thereon, and the flange 44 of the second body portion 34 includes four (4) radial ribs 52 disposed thereon. The first and second body portions 32, 34 fit together via threaded connection. The outer surface of the collar 38 of the first body portion 32 defines male threads that threadably engage female threads defined on the inner surfaces of the flange 42 and collar 44 of the second body portion 34. The ribs 50, 52 facilitate rotation of the first and second body portions 32, 34 relative to one another during threaded connection and disconnection of the first and second body portions 32, 34.

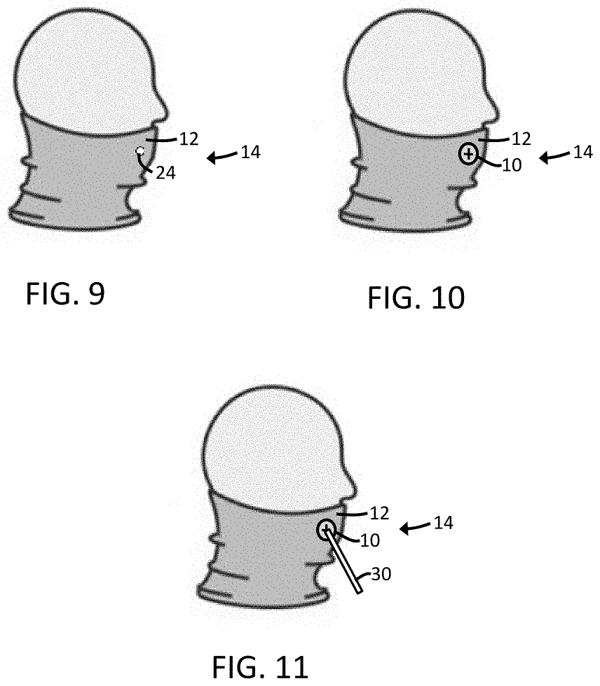

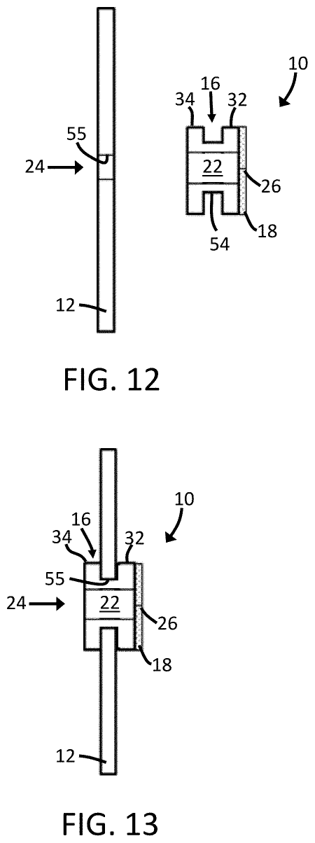

In some embodiments (see FIGS. 9-14), the first and second body portions 32, 34 of the device 10 are integrally connected to one another. In some such embodiments, the device 10 is configured to be installed into a pre-defined hole 24 in the mask 12. Referring to FIGS. 12-14, in the illustrated embodiment, the first and second body portions 32, 34 of the device 10 are integrally connected to one another and define an annular groove 54 (see FIG. 12) therebetween. The device 10 is configured to be installed into a pre-defined hole 24 in the mask 12 (see FIG. 9). The mask 12 is made of a flexible material. The user stretches the material to expand the size of the pre-defined hole 24 and thereby permit installation of the device 10. Once installed, the groove 54 of the body 16 engages the edge 55 (see FIGS. 12-13) of the mask 12 that defines the hole 24.

In some embodiments (see FIGS. 1-8), the device 10 includes more than one membrane 18, 20, and/or each membrane 18, 20 includes more than one slit 26, 28. Referring to FIGS. 7 and 8, in the illustrated embodiment the device 10 includes a first membrane 18 disposed relative to first body portion 32 of the device 10, and a second membrane 20 disposed relative to the second body portion 34 of the device 10. The first membrane 18 includes four (4) slits 26 that intersect at a center of the first membrane 18, and the second membrane 20 includes four (4) slits 28 that intersect at a center of the second membrane 20.

In other embodiments (see FIGS. 9-14), the device 10 includes a single membrane 18 disposed relative to one of the first and second body portions 32, 34. Referring to FIGS. 12-14, in the illustrated embodiment the device 10 includes a single membrane 18 disposed relative to the first body portion 32 of the device.

The body 16 and the one or more membranes 18, 20 of the device 10 can be made of various types of materials. In the illustrated embodiments, the body 16 is made of a rigid plastic material, and the membranes 18, 20 are made of a flexible rubber that is overmolded onto the body 16.

The mask 12 is a respirator mask, an n95 mask, a surgical mask, a buff, a neck gaiter, or another component that covers at least the mouth of a user. Referring to FIGS. 1-2, in the illustrated embodiment the mask 12 is a respirator mask with a plurality of straps 56 for mounting onto the wearer's head. Referring to FIGS. 9-11, in the illustrated embodiment the mask 12 is a buff.

The mask 12 can be made of various types of known materials, including woven materials, non-woven materials, plastics, etc.

Referring to FIGS. 2, 6, 11, 14, after the device 10 is installed relative to the mask 12, the wearer can insert a utensil 30 (e.g., a straw) to more safely permit nourishment without the need for removal of the mask 12. The wearer can remove the device 10 from the mask 12 before disposal of the mask 12. For example, in the embodiment of FIGS. 1-8, the device 10 is removed from the mask 12 by rotating the first and second body portions 32, 34 relative to one another about the axis 48 to undo the threaded connection therebetween. Once the device 10 has been removed from the mask 12, the device 10 can be reused with a new mask 12. The reusable nature of the device 10 avoids the high cost of providing a plurality of masks with the same functionality built into each mask.

While several embodiments have been disclosed, it will be apparent to those having ordinary skill in the art that aspects of the present invention include many more embodiments. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A device for removably fastening to a protective headwear to more safely permit nourishment, comprising:
a ring-shaped body having an outer surface and defining an inner opening;
the outer surface of the body mountable about a hole in the protective headwear such that the inner opening of the body at least partially overlaps with the hole;
a membrane connected to the body to substantially close the inner opening; and at least one slit in said membrane to permit passage of a utensil through the membrane.

2. The device of claim 1, wherein the outer surface of said body includes an annular groove that engages an edge of the protective headwear that defines the hole.

3. The device of claim 1, wherein said body includes a first and second body portions that engage inner and outer surfaces of the protective headwear when the first and second body portions are removably fastened together.

4. The device of claim 3, wherein one of said first and second body portions includes a sharp edge for piercing the protective headwear to form the hole.

5. The device of claim 3, wherein the first and second body portions are snap-fit.

6. The device of claim 3, wherein the first and second body portions are removably connectable via a threaded connection.

7. The device of claim 6 wherein at least one of the first and second body portions includes radial ribs to facilitate rotation of the one of the body portions relative to the other body portion for assembly and removable of said body to the headwear.

8. The device of claim 1, wherein the utensil is a straw.

9. A mask that permits drinking therethrough, comprising:
a hole in the mask in a region of a mouth of the wearer; and
a device for removably fastening to said hole in the mask, said device including:
a body having an outer surface and defining an inner opening,
a membrane connected to the body to substantially close the inner opening, and
at least one slit in said membrane to permit passage of a straw to more safely permit drinking through the mask.

10. The mask of claim 9, wherein the mask is a respirator mask.

11. The mask of claim 9, wherein the mask is an n95 mask.

12. The mask of claim 9, wherein the mask is a surgical mask.

13. The mask of claim 9, wherein the mask is a buff.

14. The mask of claim 9, wherein the mask is a neck gaiter.

15. The mask of claim 9, wherein said body includes first and second body portions that engage opposite sides the mask about said hole.

16. The mask of claim 15, wherein the first body portion includes a sharp edge that extends axially from the inner opening, and wherein the second body portion includes an annular flange that extends radially from the inner opening to receive said sharp edge when the first and second body portions are fit together to create said hole by cutting the mask.

17. The mask of claim 16, wherein the first and second body portions are fit together via snap connection.

18. The mask of claim 16, wherein the and second first body portions fit together via threaded connection.

19. The mask of claim 18, wherein at least one of said first and second body portions includes radial ribs to facilitate rotation of the one of the body portions relative to the other body portion for assembly and removable of said device to the mask.

20. The mask of claim 9 including four slits in said membrane.
